(19) United States
(12) Patent Application Publication
(10) Pub. No.: US 2016/0003635 A1
(43) Pub. Date: Jan. 7, 2016

(54) APPARATUS AND METHOD FOR PROVIDING LOCATION BASED MULTIMEDIA CONTENTS

(71) Applicant: MtoV Inc., Daejeon (KR)

(72) Inventors: Sangsu JUNG, Seongnam-si (KR); Youngsam KIM, Daejeon (KR)

(21) Appl. No.: 14/519,757

(22) Filed: Oct. 21, 2014

(30) Foreign Application Priority Data
Jul. 1, 2014 (KR) 10-2014-0081868

(51) Int. Cl. G01C 21/36; G06K 9/00; G01C 21/28; G06F 17/30

(52) U.S. Cl. CPC G01C 21/36; G06F 17/30241; G06K 9/00791; G01C 21/28; B60R 2300/207; B60R 2300/302

(57) ABSTRACT

The present invention relates to an apparatus and a method for providing location based multimedia contents, the method including: transmitting location based multimedia contents including location information and time information, multimedia information and additional information; matching and storing the location information, the time information, the additional information and the multimedia information from the transmitted location based multimedia contents in an information storing unit; searching for and extracting the location based multimedia information, in which a search position is a destination; generating and displaying at least one of the location based multimedia information provided from the information search unit as a list in the information output unit; generating and displaying a location based multimedia contents screen including a location control object, a time control object and a multimedia output object based on the location based multimedia information.

### BACKGROUND OF THE INVENTION

1. Field of the Invention

The present invention relates to an apparatus and a method for providing location based multimedia contents for conveniently controlling and receiving various routes by connecting and controlling a plurality of location based multimedia contents, in which locations intersect with each other.

2. Description of the Related Art

As generally known in the art, navigation markets are rapidly developed through the development and the propagation to the public of location based information systems, such as a global positioning service (GPS) or a Galileo project, so that a way finding service to find a destination based on present location information of a user is provided, 2-D map information is replaced with 3-D map information, and real-time traffic information is provided based on satellite information or terrestrial information.

Recently, map information, which was individually corrected and updated by a user, can be updated without an additional effort by the user through a wireless communication network, and the updating of the map information through the wireless communication network faces commercialization.

Meanwhile, a conventional navigation system uses a timeline to control and display location based multimedia contents, and has problems of being unable to control multimedia contents based on location information because the system is based on time information.

In addition, the multimedia contents cannot be controlled based on the location information in small screens such as mobile communication terminals (for example, smart phones, smart cars, wearable devices, etc.) in which a navigation application is installed, even when a non-linear timeline, which can be used for precisely controlling multimedia, is used.

As related arts, there is Korean Unexamined Patent Publication No. 10-2010-0083037 (Real map information providing method and system thereof)

### SUMMARY OF THE INVENTION

The present invention provides an apparatus and a method for providing location based multimedia contents for conveniently controlling and receiving various routes by connecting, controlling and displaying a plurality of location based multimedia contents, in which locations intersect with each other.

In addition, the present invention provides an apparatus and a method for providing location based multimedia contents for providing the location based multimedia contents according to a route in an intersection by using location information, time information and multimedia information with respect to a plurality of the location based multimedia contents.

Further, the present invention provides an apparatus and a method for providing location based multimedia contents for conveniently providing the location based multimedia contents according to a modification and control by a user through providing a location control object and a time control object in the displayed location based multimedia contents and modifying and controlling each object.

An objective of an embodiment of the present invention is not limited to the objectives described above, and it will be fully understood by those of ordinary skill in the art about other objectives not described from the following disclosure.

According to an embodiment of the present invention, there is provided an apparatus for providing location based multimedia contents including: an information input unit including a GPS receiver and a camera and transmitting location based multimedia contents including location information and time information collected by the GPS receiver, multimedia information corresponding to an image and a sound provided from the camera and additional information which is selectively added; an information storing unit storing the location information, the time information, the additional information and the multimedia information from the transmitted location based multimedia information in match with each other; an information search unit to search for and extract the location based multimedia information, in which the search position is a destination, from the information storing unit when the search position to be searched is inputted; an information output unit to generate and display a list of at least one of the location based multimedia information provided from the information search unit, to generate and display a location based multimedia contents screen including a location control object, a time control object and a multimedia output object based on the location based multimedia information corresponding to a selected item when one of items in the list is selected, and to generate and display a conversion item in the multimedia output object for route conversion when a proximity of an intersection of the selected route and a different route is reached in a case that the different route including the displayed location based multimedia information exists; and a controller to control an overall operation of the information input unit, an information extraction unit, the information storing unit, the information search unit and the information output unit, and to process the location control object, the time control object and the multimedia output object, which are displayed through the information output unit, according to a selection for the objects to display the objects through the information output unit.

According to an embodiment of the present invention, there is provided a method for providing location based multimedia contents including: transmitting location based multimedia information including location information and time information collected through a GPS receiver, multimedia information corresponding to an image and a sound provided from a camera and additional information, which is selectively added, by an information input unit; matching and storing the location information, the time information, the additional information and the multimedia information from the transmitted location based multimedia contents in the information storing unit; searching for and extracting the location based multimedia information, in which the search position is the destination, from the information storing unit in an information search unit when the search position to be searched is inputted; generating and displaying at least one of the location based multimedia information provided from the information search unit as a list in an information output unit; and generating and displaying a location based multimedia contents screen including a location control object, a time control object and a multimedia output object based on the location based multimedia information corresponding to a selected item when one of items in the list is selected, and generating and displaying a conversion item in the multimedia output object for route conversion when a proximity of an intersection of a selected route and a different route is reached in a case that the different route including the displayed location based multimedia information exists in the information output unit.

According to the present invention, it is possible to conveniently control and receive various routes by connecting, controlling and displaying a plurality of location based multimedia contents, in which locations intersect with each other.

In addition, according to the present invention, it is possible to provide the location based multimedia contents according to a route in an intersection by using location information, time information and multimedia information with respect to a plurality of the location based multimedia contents.

Further, according to the present invention, it is possible to conveniently provide the location based multimedia contents according to a modification and control by a user through providing a location control object and a time control object in the displayed location based multimedia contents and modifying and controlling each object.

### BRIEF DESCRIPTION OF THE DRAWINGS

FIG. 1 is a block diagram of a system for providing location based multimedia contents according to an embodiment of the present invention.

FIG. 2 is a block diagram of an apparatus for providing the location based multimedia contents according to an embodiment of the present invention.

FIG. 3 is a block diagram illustrating a process for providing the location based multimedia contents according to another embodiment of the present invention.

FIGS. 4a to FIG. 4g are diagrams illustrating the location based multimedia contents according to an embodiment of the present invention

### DETAILED DESCRIPTION OF THE INVENTION

Advantages and features of embodiments of the present invention, and schemes of achieving the advantages and features will be apparently comprehended by those skilled in the art based on the embodiments, which are described later in detail, together with accompanying drawings. The present invention is not limited to the following embodiments but includes various applications and modifications. The present embodiments will make the disclosure of the present invention complete, and allow those skilled in the art to completely comprehend the scope of the present invention. The present invention is only defined within the scope of accompanying claims. The same reference numerals will be assigned the same elements throughout the specification.

In the following description of embodiments of the present invention, if the detailed description of generally-known functions or configurations may make the subject matter of the present invention unclear, the detailed description of the generally-known functions and configurations will be omitted. In addition, terminologies used in the following description are defined based on functions of the present invention, and may be varied depending on the intents of a user or an operator, or a custom. Accordingly, the terminologies should be defined based on the overall contents of the specification.

Hereinafter, embodiments of the present invention will be described in detail with reference to the accompanying drawings.

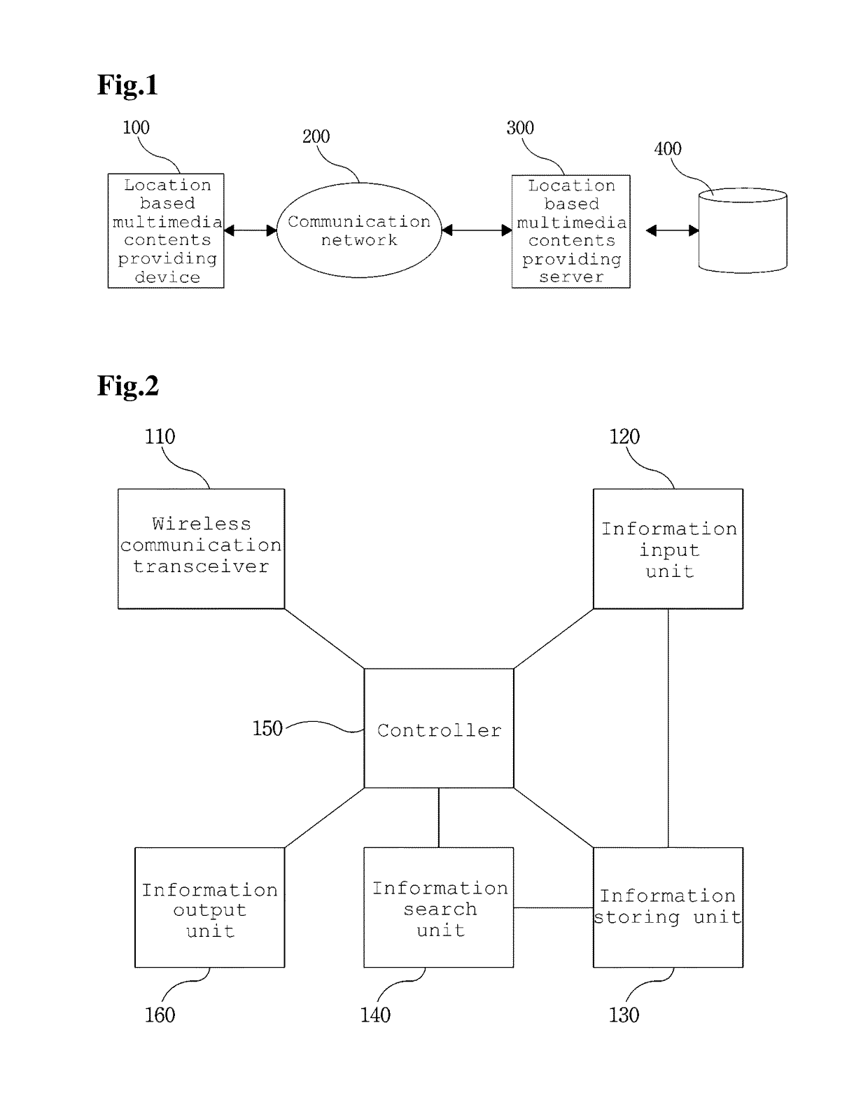

FIG. 1 is a block diagram of a system for providing location based multimedia contents according to an embodiment of the present invention, and FIG. 2 is a block diagram of an apparatus for providing a location based the multimedia contents according to an embodiment of the present invention.

Referring to FIG. 1 and FIG. 2, the system for providing the location based multimedia contents according to an embodiment of the present invention may include location based multimedia contents providing device 100, a communication network 200, a location based multimedia information providing server 300 and a location based multimedia information database 400.

The location based multimedia contents providing device 100 includes a mobile communication terminal, a tablet PC, a smart phone, a laptop, a PDA, a navigation terminal, a wearable device, a smart car and an automatic vehicle, and may include a wireless communication transceiver 110, an information input unit 120, an information storing unit 130, an information search unit 140, a controller 150 and an information output unit 160.

The wireless communication transceiver 110 includes a 3G, 4G, and various wireless communication module that will be realized in the future such as a WiFi scheme, a CDMA scheme, LTE scheme, etc., to provide a wireless communication environment through transceiving the wireless communication signal between the location based multimedia contents providing device 100 and the location based multimedia information providing server 300 by the communication network 200, in which a corresponding communication scheme is implemented.

The information input unit 120 includes a GPS receiver to receive location information from a GPS satellite and a camera to photograph an image, and transfers the location based multimedia information including the location information and time information collected through the GPS receiver, and the multimedia information, which is a set of a frame image corresponding to the image provided by the camera, to the image storing unit 130.

The information storing unit 130 matches the location information, the time information, and the multimedia information and stores as the location based multimedia information, and these information may be extracted according to needs and provided to the information search unit 140.

Also, the location based multimedia information stored in the information storing unit 130 is matched with additional information (for example, text, image, audio, etc.) according to needs and stored.

Of course, the location based multimedia information stored in the information storing unit 130 is extracted periodically or according to a selection by a user and transferred to the location based multimedia information providing server 300 through the wireless communication transceiver 110.

The information search unit 140 searches and extracts the location based multimedia information, in which a search position is a destination, from the information storing unit 130 when the user inputs the search position to be searched.

Also, the information search unit 140 searches and downloads the location based multimedia information having the search position as the destination from the location based multimedia information providing server 300 with respect to the inputted search position.

The information search unit 140 provides at least one of the searched and extracted location based multimedia information to the information output unit 160.

The controller 150 performs an overall operation control of the wireless communication transceiver 100, the information input unit 120, the information storing unit 130, the information search unit 140 and the information output unit 160 according to the selection of the user.

Specifically, the controller 150 processes corresponding commands according to the selection of the user with respect to the location control object, the time control object and the multimedia output object displayed through the information output unit 160 so that the corresponding commands are displayed through the information output unit 160.

The information output unit 160 generates and displays at least one location based multimedia information provided from the information search unit 140 as a list. Here, alignment of the list may be performed according to any one criterion among a number of inquiries, a number of suggestions, a distance and a required time.

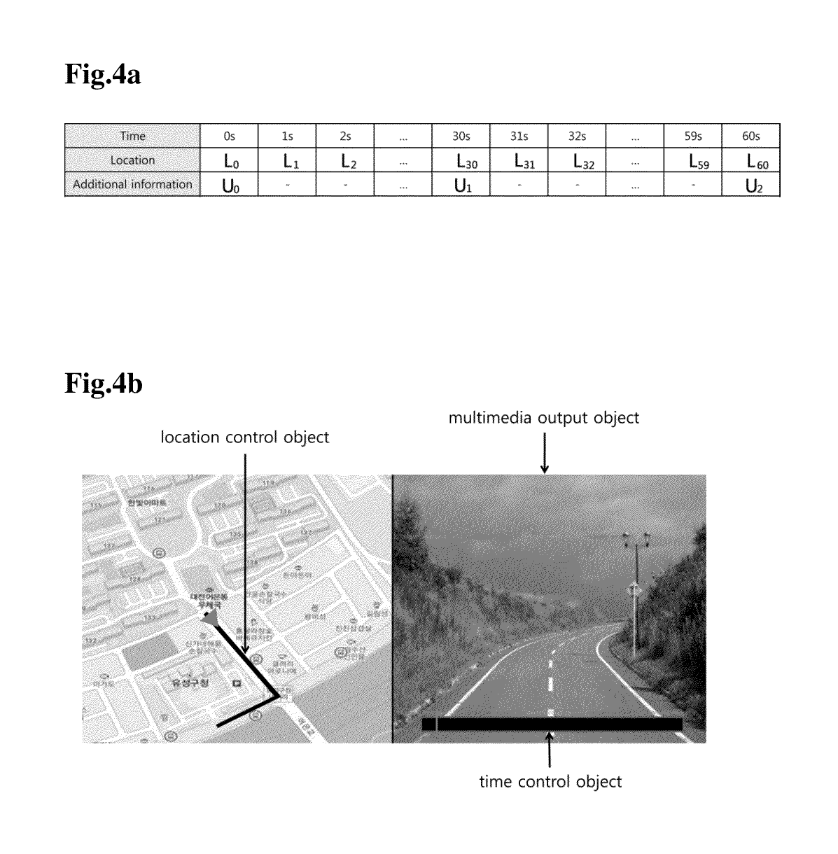

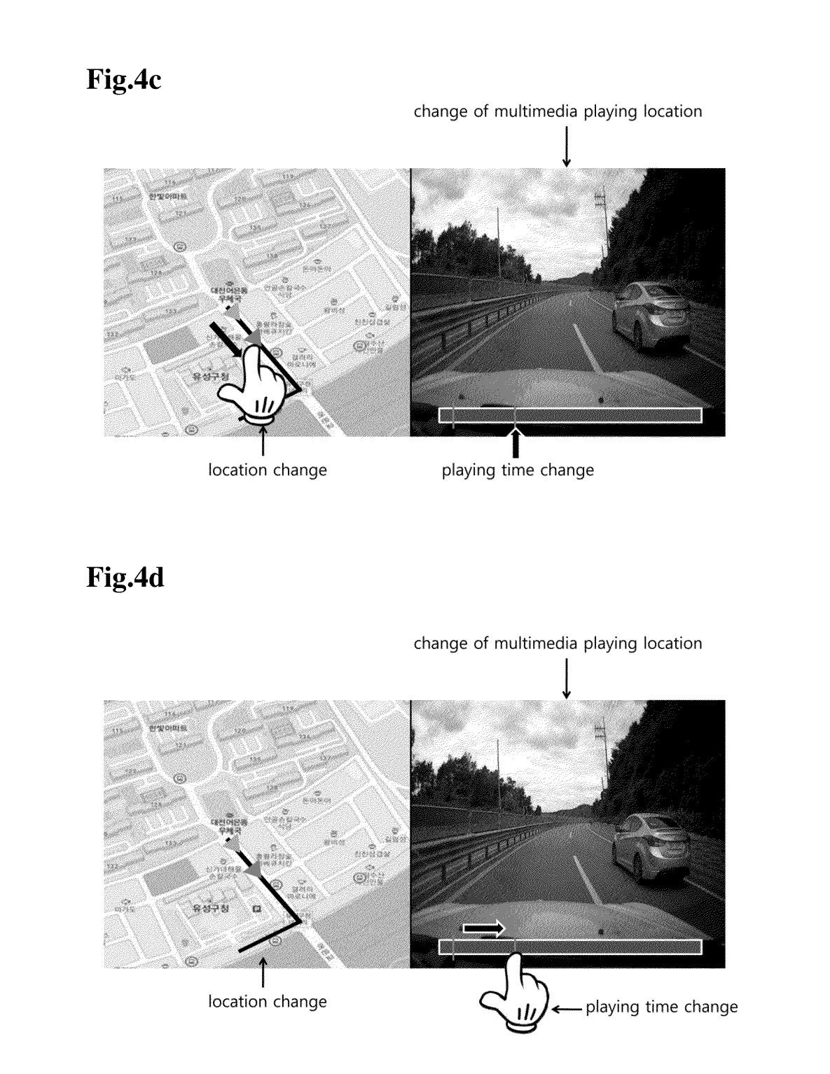

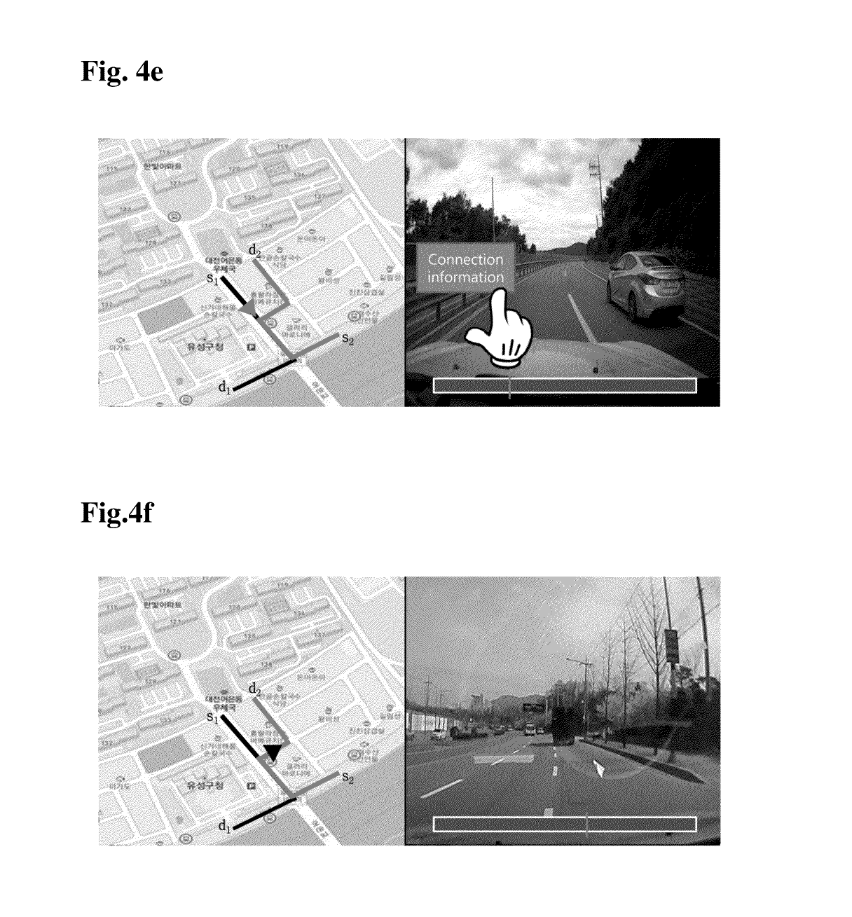

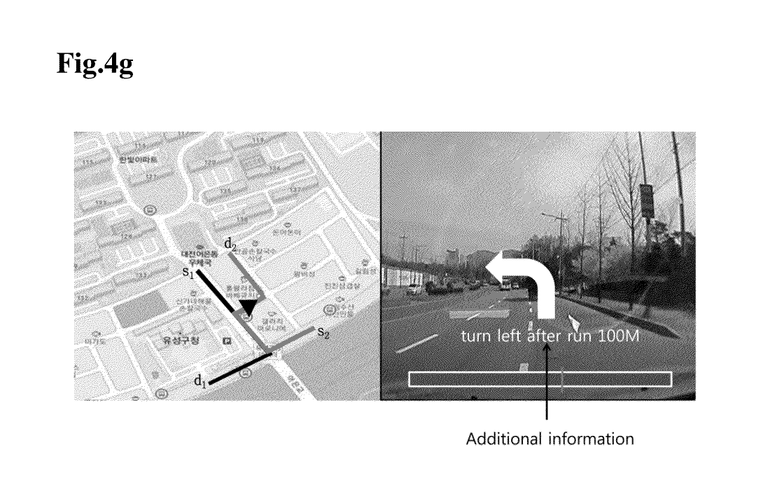

The information output unit 160 generates a location based multimedia contents screen including the location control object, the time control object and the multimedia output object based on the location based multimedia information corresponding to a selected route according to the control of the controller 150 and displays as illustrated in FIG. 4b when the user selects any one among the list.

Here, the location control object is displayed in such a manner that the user may intuitively figure out a playing location of the multimedia (that is, collected location) by displaying on map data, and corresponding routes are connected when a different route including the selected location based multimedia information exists. FIG. 4e illustrates a display including a route selected by the user (blue) and a different route including the selected multimedia information (red), and a conversion item (that is, connection information), which converts the location based multimedia information, is generated in the multimedia output object and displayed when the playing location of the location based multimedia selected by the user arrives close to an intersection.

And, the location based multimedia contents screen is generated, converted and continuously displayed based on the location based multimedia information corresponding to the different route from the intersection location when the corresponding item is selected through the information output unit 160.

Also, the information output unit 160, as illustrated in FIG. 4c, alters and displays the time and the multimedia through a selective movement of the location control object, and as illustrated in FIG. 4d, alters and displays the time and the multimedia through a selective movement of the time, and when the conversion item (that is, connection information) is selected as illustrated in FIG. 4e, a (s1, d1) route is connected to a (s2, d2) route and converted as illustrated in FIG. 4f.

Also, the information output unit 160 outputs the additional information as in FIG. 4g even when the additional information matching the time information or the location information exists.

Meanwhile, the information output unit 160 outputs a real-time image and the additional information in the multimedia output object as in augmented reality by using real-time location information inputted from the GPS and the real-time image inputted from the camera, which are not images stored with respect to the location based multimedia information.

The described location based multimedia contents providing device 100 is described as including the wireless communication transceiver 110, but the location based multimedia contents providing device 100 may be provided without the wireless communication transceiver 110, and in this case, the location based multimedia contents individually generated and stored may be provided without the wireless communication or downloading with the location based multimedia contents providing device 100.

The communication network 200 provides a wire-wireless communication environment between the location based multimedia contents providing device 100 and the location based multimedia information providing server 300 through a communication module such as CDMA, Wi-Fi, LTE, etc.

The location based multimedia information providing server 300 databases and stores the location based multimedia information to the location based multimedia information database 400 when the location based multimedia information is transmitted from the location based multimedia contents providing device 100 through the communication network 200, and the location based multimedia information corresponding to a corresponding search position is searched from the location based multimedia information database 400 when the location based multimedia information corresponding to the search position from the location based multimedia contents providing device 100 is requested for searching and its search result may be transferred to the location based multimedia contents providing device 100.

Meanwhile, as described above, the information storing unit 130 and the information search unit 140 are identically provided in the location based multimedia information providing server 300, and a greater amount and a variety of the location based multimedia information may be provided in the location based multimedia contents providing device 100 through these configurations.

Therefore, various routes are conveniently controlled and provided by connecting and controlling a plurality of the location based multimedia contents, in which locations intersect with each other, and displaying the location based multimedia contents.

Also, the present invention provides the location based multimedia contents according to the route in the intersection using the location information, the time information, and the multimedia information with respect to the plurality of the location based multimedia contents.

Also, the present invention conveniently provides the location based multimedia contents according to a manipulated control of the user by providing the location control object and the time control object in the displayed location based multimedia contents and manipulating and controlling each object.

Hereinafter, a process for processing and providing the location based multimedia contents according to the location information, the time information, and the multimedia information in the location based multimedia contents providing device having the configuration described above will be described.

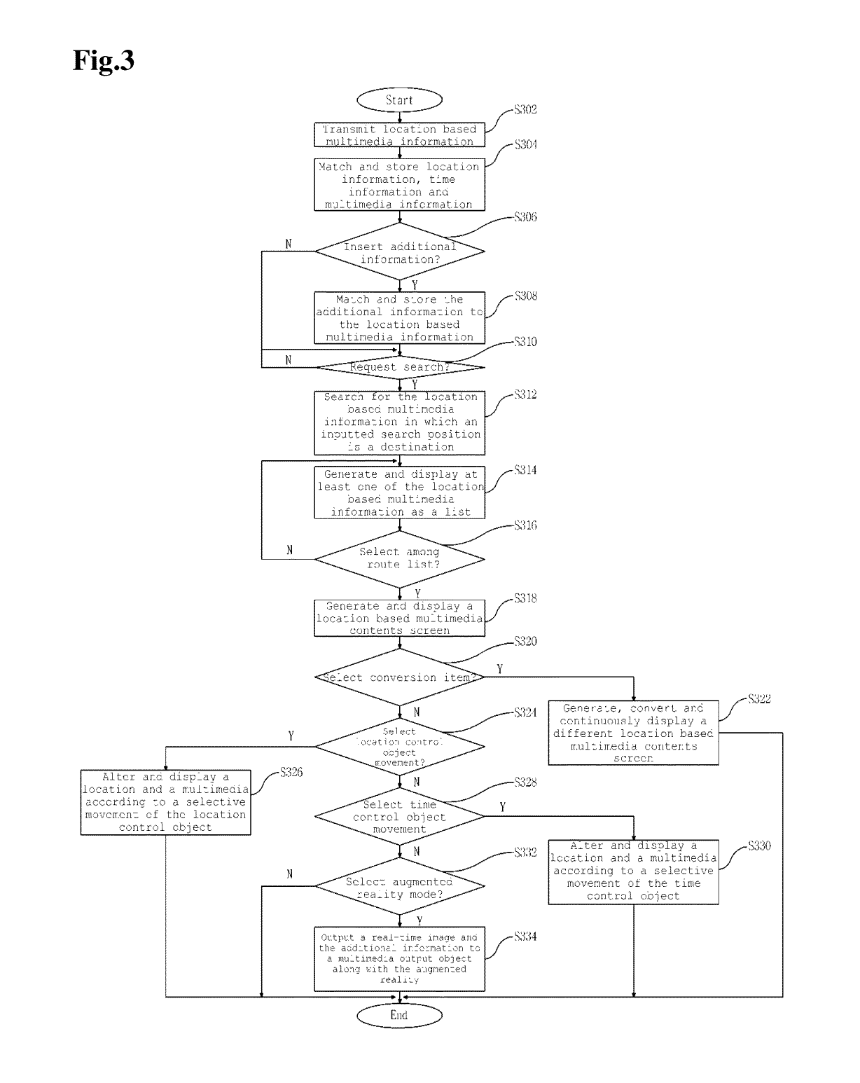

FIG. 3 is a block diagram illustrating a process for providing the location based multimedia contents according to another embodiment of the present invention.

Referring to FIG. 3, the information input unit 120 transfers the location based multimedia information including the location information and the time information collected through the GPS receiver and the multimedia information corresponding to the image and the audio provided from the camera to the information storing unit 130 S302.

And, the information storing unit 130 matches and stores the location information, time information, and the multimedia information S304.

Meanwhile, the information storing unit 130 checks if a request for inserting the additional information, which the user desires, to the location based multimedia information is inputted S306.

When the request for inserting the additional information is inputted from a result of the checking in the step S306, the information storing unit 130 stores a corresponding additional information along with the location based multimedia information in the information storing unit 130 when the additional information such as traffic information, guidance information in a form of a text, an image, an audio, etc., which the user desires to insert, is selected S308.

Meanwhile, when the request for inserting the additional information is not inputted from the result of the checking in the step S306, the information search unit 140 checks if the user requests the search by inputting the search position to be searched S310.

When the request for inserting the additional information is not inputted from the result of the checking in the step S310, the information search unit 140 stands by until the request for the search, and when the search is requested, the information search unit 140 searches and extracts the location based multimedia information, in which the search position is the destination, from the information storing unit 130 S312.

Also, the information search unit 140 as described above searches and downloads the location based multimedia information having the search position as the destination from the location based multimedia information providing server 300 with respect to the inputted search position.

Next, the information output unit 160 generates and displays at least one location based multimedia information provided from the information search unit 140 as a list S314. Here, alignment of the list is performed according to any one criterion among the number of inquiries, the number of suggestion, the distance and the required time.

And the information output unit 160 checks if the user selects any one among the list S316.

When any one among the list is selected from the result of the checking of the step S316, the information output unit 160 generates a location based multimedia contents screen including the location control object, the time control object and the multimedia output object based on the location based multimedia information corresponding to a selected route according to the control of the controller 150 and displays as illustrated in FIG. 4b when the user selects any one among the list.

Here, the location control object is displayed in such a manner that the user may intuitively figure out a playing location of the multimedia (that is, collected location) by displaying on map data, and corresponding routes is connected when a different route including the selected location based multimedia information exists. FIG. 4e illustrates a display including a route selected by the user (blue) and a different route including the selected multimedia information (red), and a conversion item (that is, connection information), which converts the location based multimedia information, is generated in the multimedia output object and displayed when the playing location of the location based multimedia selected when the user arrives close to an intersection.

And, the information output unit 160 checks if the user selects the displayed conversion item S320.

When the conversion item is selected from the result of the checking of the step S320, the location based multimedia contents screen may be generated, converted and continuously displayed based on the location based multimedia information corresponding to the different route from the intersection location when the corresponding item is selected through the information output unit 160.

Also, in the information output unit 160, when the conversion item (that is, connection information) is selected as illustrated in FIG. 4e, a (s1, d1) route is connected to a (s2, d2) route and converted as illustrated in FIG. 4f.

Also, the information output unit 160 checks if the user selects a movement of the location control object S324.

When the movement of the location control object is selected from the result of the checking of the step S324, the information output unit 160 alters and displays the time and the multimedia through a selective movement of the location control object according to the control of the controller 150 as illustrated in FIG. 4c.

And also, the information output unit 160 checks if the user selects a movement of the time control object S328.

When the movement of the time control object is selected from the result of the checking of the step S328, the information output unit 160 alters and displays the time and the multimedia through a selective movement of the time control object according to the control of the controller 150 as illustrated in FIG. 4d S330.

Meanwhile, the information output unit 160 checks if the user selects the augmented reality mode S332.

When the augmented reality mode is selected from the result of the checking of the step S332, the information output unit 160 displays a real-time image and the additional information in the multimedia output object as in the augmented reality by using the real-time location information inputted from the GPS and the real-time image inputted from the camera, which are not images with respect to the location based multimedia information S334.

Each process of the selecting and displaying the conversion item S320, S322, selecting and displaying the movement of the location control object S328, S330 and selecting and displaying the augmented reality mode S332, S334 are described for each step, but each step may react to the selection of the user and may be individually selected and displayed after the location based multimedia information is displayed.

Therefore, various routes are conveniently controlled and provided by connecting and controlling a plurality of the location based multimedia contents, in which locations intersect with each other, and displaying the location based multimedia contents.

Also, the present invention provides the location based multimedia contents according to the route in the intersection using the location information, the time information, and the multimedia information with respect to the plurality of the location based multimedia contents.

Also, the present invention conveniently provides the location based multimedia contents according to a manipulation and control of the user by providing the location control object and the time control object in the displayed location based multimedia contents and manipulating and controlling each objects.

While the present invention has been particularly shown and described with reference to various embodiments thereof, it will be understood by those of ordinary skill in the art that various substitutions, changes in form and alterations may be made therein without departing from the spirit and the scope of the present invention.

What is claimed is:

1. An apparatus for providing location based multimedia contents, the apparatus comprising:
an information input unit including a GPS receiver and a camera and transmitting location based multimedia contents including location information and time information collected by the GPS receiver, multimedia information corresponding to an image and a sound provided from the camera and additional information which is selectively added;
an information storing unit storing the location information, the time information, the additional information and the multimedia information from the transmitted location based multimedia information in match with each other;
an information search unit to search for and extract the location based multimedia information, in which the search position is a destination, from the information storing unit when the search position to be searched is inputted;
an information output unit to generate and display a list of at least one of the location based multimedia information provided from the information search unit, to generate and display a location based multimedia contents screen including a location control object, a time control object and a multimedia output object based on the location based multimedia information corresponding to a selected item when one of items in the list is selected, and to generate and display a conversion item in the multimedia output object for route conversion when a proximity of an intersection of the selected route and a different route is reached in a case that the different route including the displayed location based multimedia information exists; and
a controller to control an overall operation of the information input unit, an information extraction unit, the information storing unit, the information search unit and the information output unit, and to process the location control object, the time control object and the multimedia output object, which are displayed through the information output unit, according to a selection for the objects to display the objects through the information output unit.

2. The apparatus for providing location based multimedia contents according to claim 1, further comprising a wireless communication transceiver to provide a wireless communication environment by transceiving a wireless communication signal,
wherein the information searching unit searches for and downloads location based multimedia information having the search position set as a destination in a location based multimedia information providing server.

3. The apparatus for providing location based multimedia contents according to claim 1, wherein the information output unit generates the list by aligning the list according to one criteria among a number of inquiries, a number of recommendations, a distance, and a required time.

4. The apparatus for providing location based multimedia contents according to claim 1, wherein the information output unit alters and displays a time and a multimedia through a selective movement of the location control object, and alters and displays a location and the multimedia according to a selective movement of the time control object.

5. The apparatus for providing location based multimedia contents according to claim 4, wherein the information output unit inserts the selected additional information to a real-time image inputted from the camera to display the additional information.

6. A method for providing location based multimedia contents, the method comprising:
transmitting location based multimedia information including location information and time information collected through a GPS receiver, multimedia information corresponding to an image and a sound provided from a camera and additional information, which is selectively added, by an information input unit;
matching and storing the location information, the time information, the additional information and the multimedia information from the transmitted location based multimedia contents in the information storing unit;
searching for and extracting the location based multimedia information, in which the search position is the destination, from the information storing unit in an information search unit when the search position to be searched is inputted;
generating and displaying at least one of the location based multimedia information provided from the information search unit as a list in an information output unit; and
generating and displaying a location based multimedia contents screen including a location control object, a time control object and a multimedia output object based on the location based multimedia information corresponding to a selected item when one of items in the list is selected, and generating and displaying a conversion item in the multimedia output object for route conversion when a proximity of an intersection of a selected route and a different route is reached in a case that the different route including the displayed location based multimedia information exists in the information output unit.

7. The method according to claim 6, wherein the searching and extracting of the location based multimedia information searches and downloads the location based multimedia information, in which the search position is the destination, from the location based multimedia information providing server.

8. The method according to claim 6, wherein the generating and displaying of the list generates the list by aligning the list according to one criteria among a number of inquiries, a number of recommendations, a distance, and a required time.

9. The method according to claim 6, wherein the displaying includes changing and displaying the time and the multimedia through a selective movement of the location control object, and altering and displaying a location and the multimedia according to a selective movement of the time control object.

10. The method according to claim 9, wherein the displaying includes inserting and displaying selected additional information to a real-time image inputted from the camera.
